(19) United States
(12) Patent Application Publication
(10) Pub. No.: US 2022/0267146 A1
(43) Pub. Date: Aug. 25, 2022

(54) DECOMPOSITION OF HYDROGEN PEROXIDE AND REMOTE UTILITIES SYSTEM

(71) Applicant: HYDRODINE CATALYTICS LTD., Nisku (CA)

(72) Inventor: Ryan Thomas WOODLEY, Hinton (CA)

(21) Appl. No.: 17/678,408

(22) Filed: Feb. 23, 2022

Related U.S. Application Data
(60) Provisional application No. 63/170,800, filed on Apr. 5, 2021.
(60) Provisional application No. 63/280,764, filed on Nov. 18, 2021.

(30) Foreign Application Priority Data
Feb. 25, 2021 (CA) 3110379

(51) Int. Cl. C01B 3/04; B01J 23/50; H01M 8/0606

(52) U.S. Cl. CPC C01B 3/04; B01J 23/50; H01M 8/0606; C01B 2203/84

(57) ABSTRACT

A flow through decomposition unit has a catalyst between an inlet end and an outlet end. A hydrogen peroxide solution, at 70% by weight hydrogen peroxide or less, is pumped into the inlet end. Steam and oxygen are produced at the outlet end. A system and process provide one or more utilities to a facility, for example a natural gas wellhead separator shed. The decomposition process creates heat, which can be used to heat the facility. The oxygen produced under pressure, and can be used to provide a replacement for other pressurized gasses. Optionally, the system may generate electricity. Optionally, water produced in the process may be used for potable water, process water or to dilute a solution of hydrogen peroxide before it is decomposed. The system includes a hydrogen peroxide tank, a decomposition unit with a catalyst, a heat exchanger, optionally a steam knockout and optionally an electrical generator.

### CROSS-REFERENCE TO RELATED APPLICATIONS

This application is a non-provisional application of U.S. Application Ser. No. 63/170,800, filed Apr. 5, 2021; and U.S. Application Ser. No. 63/280,764, filed Nov. 18, 2021; and claims the benefit of Canadian Application Serial No. 3,110,379, filed Feb. 25, 2021. U.S. Application Ser. Nos. 63/170,800 and 63/280,764 and Canadian Application Serial No. 3,110,379 are incorporated herein by reference.

### FIELD

This application relates to systems and methods for decomposing hydrogen and for providing one or more utilities (for example heat, water, oxygen, a pneumatic source or energy) to a remote and/or off-grid building or other facility.

### BACKGROUND

Remote buildings are used in many industries. For example, in the oil and gas industry a separator shed may be located at a remote natural gas wellhead site. The separator shed contains a separation unit used to separate water and condensate from the natural gas produced at the wellhead before the natural gas is transferred to a pipeline connected to a processing facility. The separator shed requires one or more utilities, such as heat, water, a pneumatic source and electrical power, to operate the equipment and optionally to support workers at the site. However, the separator shed might not be near an electrical power grid.

In some examples, solar panels as used to provide electrical power to a remote building. In the case of a separator shed, the separation unit divides the raw natural gas into two streams: fuel gas stream that is used to run pneumatic devices that control the systems in the separator shed, and a raw natural gas stream that goes directly into the pipeline for further processing downstream. The fuel gas is often an inconsistent mixture of gasses with varying concentrations of contaminants. The fuel gas contains methane that is used to provide heat through a catalytic heater. The fuel gas is also used as a pneumatic source, for example as instrument air. All sensors, switches and other equipment exposed to the fuel gas are made to operate in an explosive environment, but some risk of explosion remains. Further, the fuel gas and the exhaust from the catalytic heater create greenhouse gas emissions. The use of the fuel gas to provide utilities to the building therefore increases the carbon footprint of natural gas production.

### INTRODUCTION

This specification describes a device and process for decomposing hydrogen peroxide. This specification also describes a system and process for providing one or more utilities to a facility, which may be a remote and/or off-grid facility. In some examples, the facility is a well-head separator shed. However, the system and process may be adapted for use in other facilities of applications, for example wastewater treatment.

In some examples of the device, a decomposition unit includes a flow through reaction chamber between an inlet end and an opposed outlet end of the decomposition unit. A catalyst, for example silver wool, is located between the inlet end and the outlet end. An elongated catalyst region within the reaction chamber may have a length to diameter ratio of at least 2:1. The inlet end may be connected to a source of 70% by weight or less hydrogen peroxide solution. Optionally, the inlet end has a nozzle to spray hydrogen peroxide into the catalyst. Optionally, the outlet end has a restrictor to reduce the cross-sectional area of the chamber upstream of an outlet port. The outlet port is adapted to release oxygen and steam from the decomposition device. A pump is configured to supply hydrogen peroxide to the decomposition unit such that the temperature of the reaction chamber is in a range of 100-500° C.

In some examples of the process for decomposing hydrogen peroxide, an aqueous hydrogen peroxide solution is contacted with the upstream end of a catalyst in a reaction chamber. Steam and oxygen are released from a downstream end of the catalyst. The reaction chamber is maintained at a temperature of at least 100° C. The hydrogen peroxide solution may have a hydrogen peroxide concentration of 70% by weight or less.

The process may occur in a decomposition unit as described above.

In some examples, the process for providing one or more utilities to a facility includes decomposing hydrogen peroxide (optionally as described above) over a catalyst into water and oxygen. The decomposition process creates heat, which can be used to provide space heat to the facility or heat for an industrial process. The oxygen and/or steam is optionally produced under pressure, and can be used as a replacement for other pressurized gasses or used to compress another gas such as air. Optionally, hydrogen peroxide can also be used to produce electrical power, for example in a fuel cell, and/or heat or pressure created by decomposing hydrogen peroxide can be used to produce electrical power. Optionally, water produced in the process may be used for potable water, process water or to dilute a solution of hydrogen peroxide before it is decomposed.

In some examples, the system for providing one or more utilities to a facility includes a hydrogen peroxide tank, a decomposition unit (optionally as described above) with a catalyst, a heat exchanger and optionally a gas-water separator such as a steam knockout. The heat exchanger may be connected to a radiator or forced air heating unit of a building. A gas outlet from the system may be connected to an oxygen or pneumatic supply network, or to a device for compressing air. An optional water outlet from the system may be connected to a water distribution system of a facility. Optionally, the system also includes a fuel cell, for example a direct hydrogen peroxide fuel cell, a turbine, a compound steam engine or a thermoelectric module for generating electrical power.

### BRIEF DESCRIPTION OF THE FIGURES

FIG. 1 is a schematic drawing of a utility system.

FIG. 2 is a cross section of a hydrogen peroxide decomposition unit of the utility system of FIG. 1.

### DETAILED DESCRIPTION

The inventor has observed that systems for decomposing hydrogen peroxide using a one-sided catalyst bed, wherein hydrogen peroxide is added and oxygen is produced from the top of the catalysts bed, tend to fail after several hours of operation. Water and oxygen are produced by the decomposition reaction. While some water may leave the catalyst bed with the oxygen as water vapor, over time liquid water accumulates in the catalyst bed. This water dilutes incoming hydrogen peroxide and slows the reaction, which often increases the rate of water retention. Eventually the decomposition reaction stops. In addition, the oxygen produced by the reaction oxidizes the catalyst and the catalyst must be periodically removed and regenerated. For example, Canadian Patent Application 2,824,695 by the present inventor described a steamer for thawing frozen valves or pipes using hydrogen peroxide decomposition in a one-side catalyst bed. The problem of water accumulating in the catalyst bed was addressed by draining water from the bottom of a reaction chamber holding the catalyst bed. However, if the reaction chamber was drained completely then excess unreacted hydrogen peroxide flowed out of the reaction chamber. Alternatively, if some water was retained in the reaction chamber then the incoming hydrogen peroxide was still diluted. Operating temperatures of over 90° C. could not be achieved and the catalyst also still had to be regenerated periodically.

In a hydrogen peroxide decomposition apparatus and process described herein, a catalyst is located between an inlet end and an outlet end of a flow through reaction chamber. With a flow through reaction chamber, hydrogen peroxide flows into the reaction chamber through the inlet end and at least part way through the catalyst. Decomposition products, including oxygen and water vapor, are produced in the catalyst and flow out of the outlet end of the reaction chamber. In this configuration, the expansion of gasses produced during decomposition tends to enhance a flow of gas through the catalyst that may be sufficient to entrain liquid water in the catalyst and carry it out of the reaction chamber. During start up, while the reaction chamber is cold, some liquid hydrogen peroxide may also be carried out of the reaction chamber. However, the reaction continues and the decomposition unit may reach an operating temperature of at least 100° C. such that water produced by the decomposition is vaporized. At the operating temperature, essentially complete decomposition of the hydrogen peroxide can be achieved. Further, an operating temperature of 120° C. or more, or 150° C. or more, can avoid oxidation of the catalyst for extended periods of continuous operation, for example 500 hours or more. A restriction at the outlet end of the reaction chamber increases the residence time and operating pressure of the reaction chamber. The restriction can be sized to provide essentially complete decomposition of the hydrogen peroxide, avoid water accumulating in the reaction chamber, and also produce a pressurized output stream of the decomposition products.

A hot, pressurized stream of oxygen and water vapor is produced at the outlet of the decomposition unit. Water and/or oxygen can be extracted from the outlet stream. In addition, the outlet stream can be used to provide energy in the form of heat and/or pressure, or by converting the heat and/or pressure into another form of energy. The hydrogen peroxide decomposition apparatus and process may be part of a utility system used to provide one or more of these products to a remote building or industrial process, for example a natural gas wellhead separator shed, a field hospital, a military unit or water treatment facility.

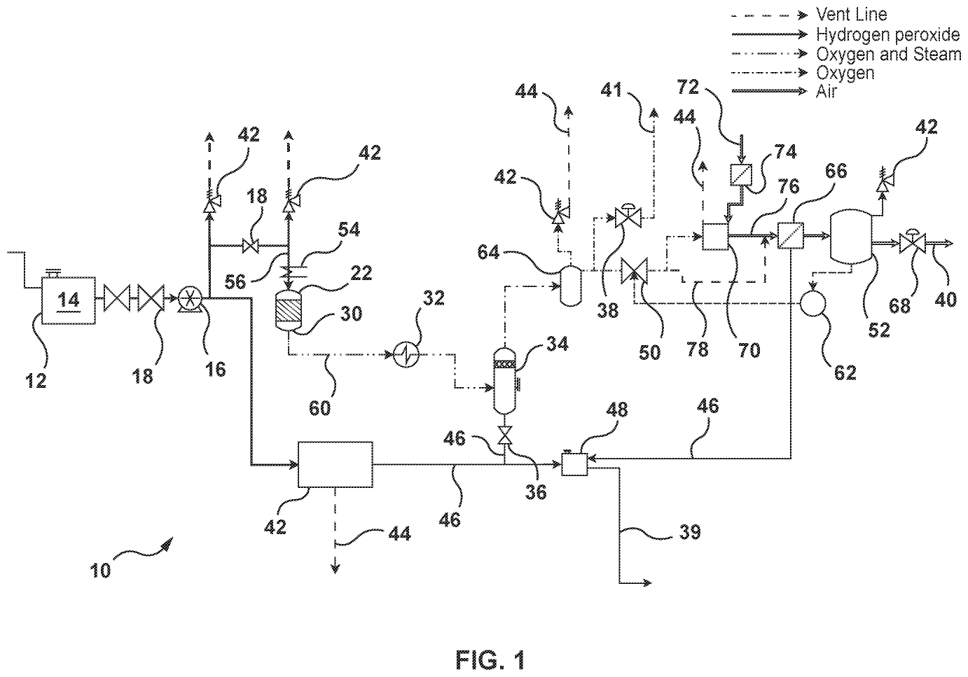

FIG. 1 shows a utility system 10. The utility system 10 includes a supply tank 12. The supply tank 12 contains an aqueous hydrogen peroxide solution 14. Optionally, the hydrogen peroxide solution 14 may have a concentration of 70% by weight or less, for example 20-65% by weight. Commercial grade hydrogen peroxide may have a concentration of 50-98% by weight as supplied in a tanker truck, although trucking hydrogen peroxide at 50-70% by weight or less is more common. Commercial grade hydrogen may be diluted for use in the system 10. Optionally, at least some water for dilution may be produced by the decomposition of hydrogen peroxide in the system 10. In some examples, the tank 12 holds 50% hydrogen peroxide. 50% hydrogen peroxide optionally refers to a mixture that is less than 50% by weight, for example 45.0-49.9% hydrogen by weight, since in some jurisdictions shipping or handling a hydrogen peroxide mixture at 50% by weight or more involves increased regulatory requirements. In other examples, tank 12 holds a mixture of at least 35% hydrogen peroxide by weight, or at least 40% hydrogen peroxide by weight, or at least 45% hydrogen peroxide by weight, but optionally less than 50% hydrogen peroxide by weight. The hydrogen peroxide in tank 12 may have been diluted from a higher concentration supplied by a tanker truck. Optionally, the hydrogen peroxide 14 may be diluted, for example to 20-35% by mass or 25-30% by mass hydrogen peroxide, after being withdrawn from tank 12 but before use in a fuel cell 42 or decomposition chamber 22 since lower concentration mixtures may be safer or less heavily regulated. However, storing the hydrogen peroxide at a concentration of 35% or more reduces the size of tank 12 and helps prevent freezing in cold climates. A mixture of hydrogen peroxide and water is a eutectic system. The freezing point of a mixture with 45-50% by mass hydrogen peroxide is less than −50° C. and declines further to −56° C. at about 61% by mass hydrogen peroxide. However, the freezing point rises with mixtures at less than about 45% by mass, or more than about 61% by mass, hydrogen peroxide. A mixture of at least 35% by mass hydrogen peroxide has a freezing point of about −33° C., which may be acceptable for some cold climates although higher amounts of hydrogen peroxide may be required in some places. Mixtures with less hydrogen peroxide are not acceptable for unheated storage outside in cold climates, for example most of Canada, but could be acceptable in warmer climates.

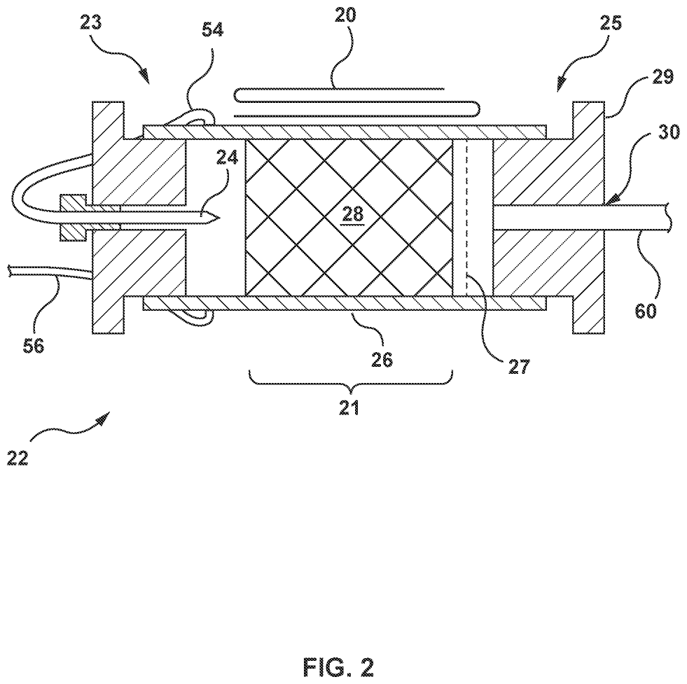

An outlet from the supply tank 12 leads to a pump 16. The pump may be, for example, a gear pump, a displacement pump or a peristaltic pump. The pump 16 provides pressurized hydrogen peroxide solution 14 at an outlet of the pump 16. The outlet of the pump 16 is connected to an inlet end 23 of the decomposition unit 22. The pressure may be sufficient to produce a mist or aerosol as the hydrogen peroxide solution passes through a nozzle 24 (shown in FIG. 2) of the decomposition unit 22. For example, the outlet pressure of the pump 16 may be in the range of 30-1000 psi, or 2-41 bar (30-600 psi), or 14-41 bar (200-600 psi) or about 350 psi. Optionally, a check valve 18 is provided to prevent backflow of hydrogen peroxide solution 14 to the pump 16. Optionally, the utility system 10 is configured, or controlled by a control system, to maintain a temperature in the range of 100-500° C. in the decomposition unit 22. Temperature in the decomposition unit 22 is primarily influenced by the operating pressure of the decomposition unit 22, but may also be influenced by the feed flow rate of pump 16.

The hydrogen peroxide solution 14 is sent under pressure to a decomposition unit 22. Further details of the decomposition unit 22 are shown in FIG. 2. Optionally, the decomposition unit 22 may be oriented horizontally. The decomposition unit 22 has an inlet end 23 and an outlet end 25. The decomposition unit 22 includes a reaction chamber 26, which may also serve as the main structural body of the decomposition unit 22. In the example shown, the reaction chamber 26 is an assembly of multiple pipe segments with caps at each end. In other examples, the reaction chamber 26 may be made from one or more sections of pipe with caps at each end. In an example, the inside diameter of the reaction chamber 26 is in the range of 15 to 80 mm and the length of the reaction chamber is in the range of 10-30 cm long. The reaction chamber 26 may be made, for example, of steel. Inlet tubing 56 to the reaction chamber 26 may be ¼″ (6 mm) stainless steel tubing. Outlet tubing 60 may be ⅜″ (9 mm) or ½″ (12.5 mm) stainless steel tubing. The outlet tubing 60 may have an interior cross-sectional area in the range of 5-50%, or 10-30%, of the interior cross-sectional area of the reaction chamber 26. Optionally, the reaction chamber and/or the decomposition unit may be curved or otherwise non-straight. The decomposition unit 22 contains a nozzle 24 at one end of the reaction chamber 26. The nozzle 24 produces a stream of aqueous hydrogen peroxide flowing inside the reaction chamber 26. The stream may be continuous but a discontinuous stream such as a spray, mist or aerosol more reliably produces essentially complete decomposition of the hydrogen peroxide. The reaction chamber 26 also contains a catalyst 28 in a catalyst region 21 of the reaction chamber 21. The catalyst 28 may include one or more catalytic materials such as manganese dioxide, lead dioxide, silver or platinum. Optionally, the catalytic material may be provided on a supporting material. The catalyst 28 is preferably configured to provide a high surface area. The reaction chamber 26, or the catalyst region 21, may have a ratio of length to inside diameter of 2:1 or more or 4:1 or more. For a non-cylindrical reaction chamber, or a cylindrical reaction chamber with a varying diameter, an equivalent length to diameter ratio is calculated using the diameter or a circle having a cross-sectional area equal to the inner volume of the catalyst region 21 divided by the length of the catalyst region 21.

A pre-heat element 20 is used to warm the decomposition unit 22 before a cold start. The pre-heat element 20 warms the outside of the decomposition unit 22, which thereby warms the inside if the decomposition unit 22 and the catalyst 28 within it. A hydrogen peroxide pre-heat unit 54 pre-heats the hydrogen peroxide flowing though inlet tubing 56 to the decomposition unit 22. Optionally, the hydrogen peroxide pre-heat unit 54 can be made by passing some of the inlet tubing 56 along the surface of the decomposition unit 22. In this way, the hydrogen peroxide is warmed by the decomposition unit 22 before entering the decomposition unit 22. The pre-heat element 20 may be operated from a battery, which optionally may be charged by electricity generated by the system 10. The pre-heat element 20 may warm the decomposition unit 22 to a temperature in the range of 70-250° C. During normal operation, the decomposition unit 22 may operate at a temperature in the range of 100-500° C. or 120-250° C. or 150-250° C. An operating temperature of at least 100° C., or at least 120° C., helps to avoid water build up in the decomposition unit 22 by converting any water to steam. A pre-heat temperature in the range of at least 70° C. but less than 100° C. may allow some water to accumulate in the decomposition unit 22, but is sufficient to avoid an amount of water accumulation that would interfere with sustaining a reaction sufficient to bring the decomposition unit up to an operating temperature of at least 100° C. or at least 120° C. A temperature of at least 150° C. helps to inhibit oxidation of the catalyst and may allow sustained operation, for example for 100 hours or more, without needing to regenerate the catalyst.

In an example, the catalyst 28 comprises silver, for example in the form of nanoparticles, wires, powder or mesh. Alternatively or additionally, the catalyst 28 may comprise platinum, iridium, platinum-tin or manganese oxides. Optionally, the catalyst 28 may be coated on another material, such as silica, alumina or supported by another material such as stainless steel mesh. In some examples, the catalyst is fine silver (or silver alloy) wire, for example of about 0.05 mm diameter, in the form of a wool. A silver catalyst may be activated, or re-generated, by exposure to nitric acid. Some alternative examples of catalysts are described in U.S. Pat. Nos. 3,363,983; 3,488,962; and, 3,560,407. The catalyst 28 is located in the reaction chamber 26 downstream of the inlet end 23 and nozzle 24 and upstream of the outlet end 25 and an outlet port 30. Optionally, a screen 27 or other retaining device may be used to restrain the catalyst 28 in a selected position within the reaction chamber 26. When the catalyst 28 comprises silver wire, the wire is preferably of a diameter of 26 guage wire or more or a diameter of 23 guage wire or more. During a first start up, the hydrogen peroxide appears to deteriorate some of the silver wire. Once operating temperature is reached, the wire appears to stabilize. However, sufficient diameter is required to prevent excessive structural degredation of the wire on the first start up.

When droplets or a stream of hydrogen peroxide solution 14 contact the catalyst 28, the hydrogen peroxide decomposes into water and oxygen gas in an exothermic reaction. As a result of the heat of reaction, the water and oxygen are heated. Typically, the water is produced as steam. A restrictor 29 reduces the cross sectional area of the reaction chamber upstream of an outlet port 30 at the downstream end of the reaction chamber 26. The outlet port 30 allows oxygen and steam to leave the reaction chamber 26. However, the outlet port 30 is a relatively small opening with a size selected to produce an effective residence time and backpressure in the reaction chamber 26 such that the hydrogen peroxide is essentially completely decomposed. In some examples, the cross-sectional area of the outlet port (measured at its inner diameter) is in a range of 5-50%, or 10-30% of the cross sectional area of the reaction chamber 26 (measured at its inner diameter). Oxygen and steam (oxygenated steam) are emitted under pressure from the decomposition unit 22.

The system 10 is generally open from the outlet 30 of the decomposition unit 22 through a heat exchanger 32 and knockout 34. This reduces the possibility for blockages although pressure relief valves 42 are added at various locations where there is a possibility of pressure buildup or blockage.

The decomposition chamber 22 turns hydrogen peroxide 14 into oxygenated steam, which is converted into oxygen and condensed water. There is a possibility of some hydrogen peroxide vapour being emitted from the decomposition chamber 22, particularly after a cold start up of the system 10. In tests, there was less than 1% hydrogen peroxide in the condensed water even on a cold start up. However, the condensed water may require treatment before being used for a purpose that will not tolerate a small amount of hydrogen peroxide. For example, sodium bicarbonate may be added to the condensed water, followed by heating the water.

The pump 16 has a variable frequency drive (VFD) and is controlled by a programmable logic controller (PLC). The PLC is connected to temperature and pressure sensors associated with the decomposition unit 22 and a temperature sensor (which may be part of a thermostat) associated with a building or other unit being heated by the heat exchanger 32. The PLC may have a variety of programmed control routines. For example, in a standby routine, the PLC operates the pump 16 primarily considering the temperature sensor associated with the decomposition unit 22. In the standby mode, the PLC operates the pump 16 to provide a hydrogen peroxide intermittently or at a low flow rate to maintain a minimum standby temperature of the decomposition unit 22. In a heating mode, the PLC operates the pump 16 at a variable speed, or at one of a set of pre-determined speeds, according to the demand for heat as determined by a temperature sensor or thermostat in communication with the heat exchanger 32. In pneumatic oxygen mode, the PLC operates the pump 16 when the pressure sensor associated with the decomposition chamber (i.e. upstream of valve 50) indicates that the pressure in the decomposition chamber is below a minimum pressure threshold. The minimum pressure threshold may be sufficient to provide a desired pressure in the upstream tank and/or for an upstream tank 64 to recharge a storage tank 52 with oxygen or air. The pneumatic oxygen mode may have a single pre-determined speed for the pump 16 determined to match, or exceed by a factor of safety, the maximum expected demand for oxygen. The PLC may operate in heating mode and pneumatic oxygen mode at the same time by selecting the higher pump speed required by either mode. When neither the heating mode nor the pneumatic oxygen mode requires the pump 16 to operate, the PLC may revert to standby mode.

Returning to FIG. 1, the outlet 30 of the decomposition unit 22 leads to a heat exchanger 32. The heat exchanger 32 may contain one or more lengths of pipe that the oxygen and steam flow through. A second fluid flows around these tubes and becomes heated. In one example, the heat exchanger 32 may be a shell and tube heat exchanger and the second fluid may be water connected to a hydronic heating system. In another example, the heat exchanger 32 may be a coil or radiator and the second fluid may be air. The air may be heated by the natural convection of air past the heat exchanger 32. Alternatively, the heat exchanger 32 may be placed within a forced air heater or furnace that blows air past the heat exchanger 32 and into the room. For operation in summer months, the heat exchanger may be connected to a vent system to channel heat outdoors or located near an open window to avoid overheating a building.

The steam may be sufficiently cooled in the heat exchanger 32 to condense into water. Liquid water may be drained from the heat exchanger 32, and the heat exchanger 32 may have a pressurized oxygen outlet. Alternatively, an outlet of the heat exchanger 32 is connected to a gas-liquid separator 34, alternatively called a steam knockout. Liquid water is separated from the oxygen gas and flows periodically through an automated drain valve 36 to a water tank 48. Water may be taken from the water tank 48 for use, for example, as potable water, process water or to dilute incoming hydrogen peroxide. The water may be further treated if necessary. Tubing in the heat exchanger 32, between the decomposition unit 22 and the heat exchanger 32 and between the heat exchanger 32 and a gas-liquid separator 34, may all be sloped downwards so that all condensed water flows to the gas-liquid separator 34.

The legend in FIG. 1 relates to an example of a utility system 10 having an optional gas amplifier 70, which converts pressurized oxygen to pressurized air, and no by-pass line 78 (or a by-pass line 78 that is closed). This example will be described further below. In an alternative example, oxygen leaves the gas-liquid separator 34 for use through a first pressure regulator 38 (via first supply line 41) or through a valve 50 to a storage tank 52 by way of by-pass line 78, avoiding a gas amplifier 70 (which may be removed or isolated). Parts of the legend in FIG. 1 do not apply to this alternative example wherein the by-pass line 78 is present and the gas amplifier 70 is not used. In this alternative example, oxygen may be stored in the storage tank 52 and drawn when required for use through a second pressure regulator 68 (via second supply line 40). Optionally the second pressure regulator 68 is set to a lower pressure (i.e. 400-750 kPa) than the first pressure regulator 38 (i.e. 2000 kPa or more). The downstream ends of the first pressure regulator 38 and the second pressure regulator 68 are connected to devices or systems (not shown) that receive pressurized gas from the first supply line 41 (at relatively high pressure) or the second supply line 40 (at relatively low pressure). These devices or systems vent gas but in a restrained and/or periodic manner such that, in view of the ability of the utility system to produce gas, the system 10 downstream of the decomposition unit 22 is unlikely to be depressurized. Optionally, the first pressure regulator 38 and/or the second pressure regulator 68 may be configured or controlled to prevent the release of gas if the upstream pressure falls below a selected pressure. The storage tank 52 is kept within a pre-determined range of pressures by regulating valve 50 through a signal from a tank pressure sensor 62. When the tank pressure sensor 62 detects pressure within the tank at a lower threshold, the valve 50 is opened to release pressurized oxygen from upstream parts of the system 10 until an upper threshold of tank pressure is reached. An upstream oxygen storage tank 64 may be provided upstream of valve 50 to provide a sufficient volume of oxygen to recharge storage tank 52 without waiting for new oxygen to be produced from the decomposition unit 22 (which may be triggered by low pressure upstream of valve 50). Pressurized oxygen is thereby provided for use as a pneumatic source, for example, as instrument air, through second supply line 40. A pressure relief safety valve 42 vents excess oxygen from upstream of valve 50 if required to protect upstream equipment. A dryer 66, or a filter such as a hydrophobic membrane filter, may be placed upstream of the storage tank 52 to remove residual humidity from the oxygen. In another alternative example, valve 50 is kept closed, and optionally the valve 50 and all downstream elements are removed and the line that formerly connected to them is plugged. In this case, compressed oxygen is taken for use only through first pressure regulator 38 (which may be set to a high or low pressure) and first supply line 41.

In the utility system 10 as shown with reference to the legend in FIG. 1, oxygen 44 does not flow through by-pass line 78 (which may be removed or closed) and instead flows to a device for compressing air. In the example shown, oxygen 44 passes through a gas amplifier 70. Oxygen 44 is vented through the gas amplifier 70, which causes air 72 to be drawn, optionally through an air filter 74, into the gas amplifier 70 and compressed. Compressed air 72 produced by the gas amplifier 70 passes through a compressed air line 76 to dryer 66 and is stored in storage tank 52. The compressed air 72 is then available for use as a pneumatic source, for example as instrument air, in place of the pressurized oxygen 40 described above. The gas amplifier 70 uses energy obtained by way of oxygen 44 vented though the gas amplifier to compress ambient air 72. For example, the gas amplifier may contain a turbine to vent the oxygen 44 mechanically coupled to an air compressor to produce compressed air 72. The term “gas amplifier” is used to indicate that the flow rate of the compressed air 72 is optionally higher than the flow rate of the oxygen 44. Alternatively, the flow rate of the compressed air 72 may be the same as, or less than, the flow rate of the oxygen 44. Using compressed air 72 as the pneumatic source rather than pressurized oxygen 44 may avoid venting oxygen 44 from undesirable locations or oxidation of lubricants or seals used in instruments or other devices connected to the pneumatic source. However, pressurized oxygen can also be withdrawn for use through first pressure regulator 38 if desired. Aspects of the alternative examples described above may be applied to the utility system 10 with a gas amplifier 70. In an example of a utility system 10 (with or without gas amplifier 70), pressure relief safety valve 42 at the upstream tank 64 is set to 350 psi, first pressure regulator 38 is set to 320 psi, pressure relief safety valve 42 at the storage tank 52 is set to 150 psi, and pressure regulator 68 is set to 80 psi. Tank pressure sensor 62 is set to open valve 50 when pressure in the storage tank 52 drops below 110 psi. The fed pump 16 has a maximum outlet pressure of 350 psi or more.

Depending on the system configuration, the maximum operating pressure of the decomposition unit 22 (i.e. the pressure at the outlet end 25 of the decomposition unit 22) is limited by one or more of the pressure relief safety valves 42. However the controller may be connected to a pressure sensor, for example in communication with upstream tank 64, and maintain the operating pressure within a range below these limits by controlling the rate at which gasses are produced. The hydrogen peroxide pump 16, when operating, supplies hydrogen peroxide at a pressure higher than the operating pressure of the decomposition unit 22. The operating pressure of the decomposition unit may be in the range of, for example, 30-1000 psi, 30-600 psi, or 200-600 psi.

Optionally, the system includes hydrogen peroxide fuel cell 42, for example a direct hydrogen peroxide fuel cell, to produce electricity. The fuel cell 42 is connected to the tank 14 to receive hydrogen peroxide 12. The fuel cell 42 produces electricity and emits oxygen 44 and water 46. The oxygen 44 may be vented or, if produced at pressure, used as an additional pneumatic source. The water 46 may be sent to the water storage tank 48 for use (i.e. through the water supply line 39) or disposal.

In another option, a turbine or steam engine, optionally a compound steam engine, between the outlet 30 of the decomposition unit 22 and the heat exchanger 32 is used to create rotating shaft energy. The rotating shaft may be, for example, coupled to a generator or alternator to produce electricity or couple to a machine such as the gas amplifier ## described above. The pressure in the decomposition unit 22 is higher than in the rest of the system due to steam expansion. The steam expansion may be used to drive the turbine or steam engine. Preferably, a by-pass is provided around the turbine or steam engine to selectively allow the outlet 30 of the decomposition unit 22 to be connected directly to the heat exchanger 32.

In another option, a thermoelectric generator (alternatively called a Seebeck generator) is used to create electricity. The decomposition unit 22 is used as the heat source. The decomposition unit 22 may be wrapped, for example with copper or aluminum, for heat transfer and to provide a generally flat surface with a larger surface area than the decomposition unit 22. One or more thermoelectric modules are mounted on the decomposition unit 22, or the copper or aluminum wrapping. A heat sink or radiator is added to the cold side of the thermoelectric module. The heat sink may be cooled, for example, by natural convection of air, forced flow of air i.e. from a fan, or water circulated, for example, from the water tank 48. In some examples, the heat sink is a finned copper or aluminum block.

The system 10 may be combined with a natural gas wellhead separator shed. The heat exchanger 32 of the system 10 may be located inside of the shed. Air passes over the heat exchanger 32 by natural convection to provide space heating, i.e. heating the air inside of the separator shed. Pressurized oxygen from the system is used to replace pressurized fuel gas as a pneumatic source, i.e. for instrument air. Optionally, the tank 12 may be connected to a fuel cell, for example a direct hydrogen peroxide fuel cell, to produce electricity for use in the separator shed. Alternatively, another means of generating electricity describe herein may be used.

The use of hydrogen peroxide reduces the emissions of greenhouse gasses from the wellhead separator shed. Even when greenhouse gas emissions resulting from the production and transportation of hydrogen peroxide are accounted for, the system described herein may result in an 85% or greater reduction in greenhouse gas emissions from the separator shed.

The system may also be used to provide one or more utilities to another facility. For example, the system may be combined with a wastewater treatment, facility, a greenhouse or a fish farm. Air is frequently blown into aerators in water tanks to oxygenate the water. The system 10 produces pressurized oxygen that may be blown into the aerators. In some examples, electrically powered pumps are not required and the oxygen gas produced in the system oxygenates the water more effectively than air.

In an example, a utility system 10 is used to provide heat to an oilfield separator building in Alberta, Canada. A decomposition unit 22 is made generally as shown in FIG. 2. The reaction chamber 26 is made from a piece of ¾″×0.065 stainless steel tubing that is 18″ long. The catalyst 28 is about 1 kg of silver wire wool, which is activated as described above and compressed into the reaction chamber 26. Tubing connecting the hydrogen peroxide pump to the inlet end of the decomposition unit is ¼″ stainless steel tubing. Tubing connecting the outlet end of the decomposition unit the to steam knockout is ⅜″ stainless steel tubing. The steam knockout is made from 1″ pipe fittings with a liquid drainer attached. The upstream oxygen storage tank is an oxygen welding tank with pressure regulated with a Swagelok(™) back pressure regulator.

The decomposition unit 22 is part of an example system 10 generally as shown in FIG. 1, but with valve 50 closed and without the gas amplifier 70 and downstream elements. The example system 10 also does not have fuel cell 42. Heat exchanger 32 is a coil of ⅜″ stainless steel tubing in direct contact with the air in the separator building. The system controller is connected to a thermostat in the separator building, and to the various pumps, valves and sensors of the example system 10. First pressure regulator 38 is configured to prevent the release of pressurized oxygen if the upstream oxygen is below a selected pressure, and then to vent oxygen to maintain the selected pressure.

The example system 10 is fed with a hydrogen peroxide solution 14 having 50% hydrogen peroxide by weight. The feed flow rate is variable within a range of 5 litres per day (about 3 mL/min) to 40 litres per day (about 30 mL/min). Based on calculations, decomposing 1 L of hydrogen peroxide produces 1500 BTU of heat and 240 L of 99.9% O2 at atmospheric pressure. The design standard for heating at the location of the separator building is 20 Btu per square foot/per hour. The average size of an oilfield separator building is roughly 8′×10′, or 80 square feet. The separator building requires 1600 BTU per hour. Steam knockout 34, water tank 48 and upstream tank 64 are also located in the separator building such that there is almost no heat loss through the exhausted water or oxygen and the system 10 provides close to 100% heating efficiency. The separator building can be heated by the decomposition of hydrogen peroxide at a rate of 1.1 L per hour, or 26 L per day. Accordingly, the example system 10 is expected to generate sufficient heat for the building.

The example system 10 was operated at pressures in the decomposition unit 22, as determined by the pressure regulator 38, in the range of 100 psi to 1000 psi. Temperature of the decomposition unit 22, and the exhaust gasses, while operating at a steady hydrogen peroxide flow rate is primarily dependent on the pressure in the decomposition unit 22. At a pressure of 500 psi, the decomposition unit 22 has a temperature of about 210° C. At a pressure of 150 psi, the decomposition unit 22 has a temperature of about 185° C.

The controller in the example system 10 is linked to a thermostat that senses the temperature of air heated by the system 10. In this example, the thermostat operates according to a simple ON-STANDBY control algorithm to hold a selected temperature. When a temperature is measured that is less than the selected temperature minus 1 degree, the controller puts the example system 10 into an ON mode. The example system 10 operates in the ON mode until the measured temperature reaches the selected temperature plus 1 degree. The controller then puts the example system 10 into the STANDY mode until the measured temperate returns to the selected temperature minus 1 degree. The example system 10 thereby cycles between ON and STANDBY to maintain the measured air temperature near the selected temperature.

While the example system 10 is operated in the ON mode, the feed flow rate is 30 mL/min. Optionally, a different control algorithm could be used wherein a set of feed flow rates, or variable calculated feed flow rates, are used in the ON mode. In the STANDBY mode, feed flow is initially stopped but the controller maintains the decomposition unit 22 at a selected minimum temperature, for example 100° C. During periods of high heat demand, no action may be required since a demand to return to the ON mode may occur before the decomposition unit 22 cools to the minimum temperature. During periods of low heat demand, the temperature of the decomposition unit 22 may drop to the minimum temperature during the STANDBY period. If this occurs, the controller produces a feed flow rate of 3 mL/min. The controller may hold this low feed flow rate until the next demand to return to the ON mode. Alternatively, the controller may cycle between stopping feed flow and provided hydrogen peroxide solution at the low feed flow rate as required to maintain the decomposition unit 22 at or above the minimum temperature. In another alternative, the low feed flow rate may be supplied throughout the STANDBY mode.

When a demand for heat is not expected for a long period of time, for example during summer, the example system 10 is turned OFF. In the OFF mode, feed flow is stopped and the controller no longer responds to the thermostat. The decomposition unit 22 is allowed to cool to ambient temperature. At the return of the heating season, the example system 10 is retuned to the ON-STANDBY mode of operation. The controller first activates the pre-heat element 20 to warm the decomposition unit 22 to the minimum temperature. When the minimum temperature is reached, the controller places the example system 10 in STANDBY mode. The controller then resumes responding to the thermostat.

In other examples, the size of the decomposition chamber 22 may vary depending on the feed flow rate required to satisfy one or more of a demand for heat, a volume of oxygen produced, a pressure energy of steam and/or oxygen produced, or a volume of water produced.

In another example, a utility system 10 is used to produce heat, and optionally oxygen, but heat is distributed through a liquid system such as a liquid filled radiator or a heated water tank providing a thermal mass. In this example, heat exchanger 32 is omitted and the outlet tubing 60 may be connected, through a back pressure regulator, directly to a water storage tank. The water in the storage tank is heated, and optionally dispersed to a radiator or other liquid filled heat exchange. Optionally, oxygen or oxygen enriched air is collected from a headspace of the water storage tank.

We claim:

1. A system for providing a utility to a facility comprising,
a hydrogen peroxide tank;
a decomposition unit with a catalyst and an inlet and an outlet end, the inlet end in communication with the hydrogen peroxide tank; and,
(a) a heat exchanger is in communication with the outlet end of the decomposition unit and a room of the facility and/or (b) the outlet end of the decomposition unit is in communication with a pressurized gas system of the facility directly or through a device to compress air and/or (c) an outlet end of the decomposition unit is in communication with a water tank.

2. The system of claim 1 further comprising a fuel cell connected to the hydrogen peroxide tank, a turbine or compound steam engine downstream of the decomposition unit, or a thermoelectric module connected to the decomposition unit, to generate electricity for use in the facility.

3. The system of claim 1 wherein the facility is a natural gas wellhead separator shed.

4. The system of claim 1 wherein the outlet end is connected to an aerator to oxygenate water.

5. The system of claim 1 wherein the outlet end is connected to a device for compressing air.

6. A process for providing a utility to a facility comprising the steps of,
decomposing hydrogen peroxide over a catalyst into steam and oxygen; and,
using heat produced by the decomposition for space heating in the facility and/or
using oxygen produced in the decomposition for process air, a pneumatic source, instrument air, to compress air, or water oxygenation at the facility.

7. The process of claim 6 comprising producing electricity in a hydrogen peroxide fuel cell, by steam expansion, or by heat differential.

8. The process of claim 6 comprising using heat produced by the decomposition for space heating in the facility.

9. The process of claim 6 comprising using oxygen and/or steam produced in the decomposition to compress air.

10. A hydrogen peroxide decomposition unit comprising,
an inlet end;
an outlet end;
a flow through reaction chamber between the inlet end and the outlet end; and,
a catalyst in the reaction chamber;
wherein the decomposition unit is adapted to receive a 70% by weight or less hydrogen peroxide solution at the inlet end and release oxygen and steam from the outlet end.

11. The decomposition unit of claim 10 wherein the catalyst comprises a metal wire wool, the metal wire comprising silver.

12. The decomposition unit of claim 10 having a catalyst region length to diameter ratio, or an equivalent length to diameter ratio, of at least 2:1.

13. The decomposition unit of claim 10 wherein the inlet end has a nozzle to spray a discontinuous stream of hydrogen peroxide into the catalyst.

14. The decomposition unit of claim 10 wherein the outlet end has an outlet port having an inner area in the range of 5-50% of the inner area of the catalyst region.

15. The decomposition unit of claim 10 comprising a pump configured to flow hydrogen peroxide to the decomposition unit to produce a reaction chamber temperature in the range of 100-500° C.

16. A process for decomposing hydrogen peroxide comprising the steps of,
flowing an aqueous hydrogen peroxide solution into the upstream end of a catalyst in a reaction chamber;
releasing steam and oxygen from a downstream end of the catalyst; and,
maintaining the reaction chamber at a temperature in the range of 100-500° C.

17. The process of claim 16 wherein the hydrogen peroxide solution has a hydrogen peroxide concentration of 70% by weight or less.

18. The process of claim 16 wherein the catalyst is located within an elongated catalyst region of the reaction chamber.

19. The process of claim 16 comprising spraying a discontinuous stream of hydrogen peroxide at the catalyst.

20. The process of claim 16 wherein the catalyst comprises silver wire having a diameter of 26 gauge wire or more.
